(19) United States
(12) Patent Application Publication
(10) Pub. No.: US 2009/0193115 A1
(43) Pub. Date: Jul. 30, 2009

(54) Monitoring/analyzing apparatus, monitoring/analyzing method and program

(75) Inventor: Takahide Sugita, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/320,586

(22) Filed: Jan. 29, 2009

(30) Foreign Application Priority Data
Jan. 30, 2008 (JP) 2008-018798

(51) Int. Cl. G06F 15/173; G06F 15/16

(52) U.S. Cl. 709/224; 709/235

(57) ABSTRACT

A receiving unit receives data of a specific protocol, transmitted from a server to a client. An extraction unit extracts status codes from the received data. A classification unit classifies the extracted status codes, into first-type status codes and second-type status codes. A judgment unit finds a receiving rate of first-type status codes and a receiving rate of second-type status codes and compares the receiving rate of first-type status codes against a threshold value thereof, and the receiving rate of second-type status codes against a threshold value thereof. From results of comparison, the judgment unit then determines whether an increase in server load has resulted from a normal traffic or an abnormal traffic.

This application is based upon and claims the benefit of priority from Japanese Patent Application No. 2008-018798, filed on Jan. 30, 2008, the entire disclosure of which is incorporated herein by reference.

### TECHNICAL FIELD

The present invention relates to a monitoring/analyzing apparatus, a monitoring/analyzing method, and a program. More particularly, the present invention relates to a monitoring/analyzing apparatus, a monitoring/analyzing method, and a program, each designed to receive and analyze data of a specific protocol transmitted from a server to a client. The present invention also relates to a communication system that incorporates therein such a monitoring/analyzing apparatus.

### BACKGROUND ART

The session initiation protocol (SIP), RFC3261, is utilized as a call processing protocol or voice over Internet protocol (VoIP). To accomplish a call processing, a SIP server is generally used. The SIP server must receive requests from a wide area. Inevitably, the SIP server likely becomes a target of attack. Since SIP is designed based on hypertext transport protocol (HTTP) and simple mail transfer protocol (SMTP), it may be exposed to the same menace as SMTP is exposed. It is known that SIP receives Spam over Internet telephony (SPIT), i.e., an annoying telephone call made by a person who has acquired, with malicious intent, a SIP-URI (Uniform Resource Identifier) from the server. This malicious act is similar to the act of obtaining an address by harvesting and then transmitting a Spam to the address thus obtained

ITU-T Y. 1530 shows the call processing quality not limited to a specific protocol. In the VoIP Promotion Association, discussions are undergoing on possible application of ITU-T Y. 1530 to SIP or similar protocols. The criteria proposed for evaluating call processing qualities compatible with SIP include receiving rates of status codes of SIP (refer to Non-Patent Document-1: http://www.telesa.or.jp/committee/voip/pdf/0507_IPCall_potocol_ver1.pdf). For example, the receiving rate of the 400th to 499th status code (hereinafter referred to as “4xx”), the receiving rate of the 500th to 599th status code (hereinafter referred to as “5xx,”) and the receiving rate of the 600th to 699th status code (hereinafter referred to as “6xx”) are used as the criteria for evaluating the call processing qualities. Status code 4xx is issued if the server cannot process the request because the request contains an error. Status code 5xx or 6xx is issued if the server fails to process the request because a large load is imposed on the server.

A technique for detecting a denial-of-services (DoS) attack is described in JP-2007-060233A. In this technique, packets are first classified into k types (k: a natural number) in accordance with the protocol types, flags and the like. Thereafter, the packets of each type, received over a specific period, are counted. Subsequently, a k-dimensional vector is generated from the numbers of packets, the vector consisting of elements of k types. Next the distance between a main-component axis and the generated k-dimensional vector is measured. Thereafter, it is determined whether or not abnormality, i.e., DoS attack, exists from the distance thus measured. It is to be noted that the “main-component axis” refers to the correlation of the components forming a k-dimensional characteristic space.

Any server that issues many status codes 5xx or 6xx is considered to assume a high-load state. It is difficult, however, to determine whether the increase of load has resulted from a normal traffic or an abnormal traffic, even if the receiving rate of status codes 5xx or 6xx is referred to. The “abnormal traffic” is a traffic resulting from the SPIT or the DoS attack. If the factor of the load increase is unknown, the server manager has no reliable way of determining whether to enhance the ability of the server or to take security measures. In the technique described in JP-2007-060233A, the packets are classified in accordance with the protocol levels of the transmission control protocol (TCP), user data protocol (UDP) or Internet control message protocol (ICMP), or with the flag level of the TCP. In this technique, only layer 3 and layer 4 are taken into account. Therefore, the abnormality of the application level cannot be detected, so long as no abnormality is detected of layer 3 or layer 4.

### SUMMARY OF THE INVENTION

It is an object of the present invention to provide a monitoring/analyzing apparatus, a monitoring/analyzing method, and a program, each designed to infer the cause of an event that has occurred on a network.

The present invention provides a monitoring/analyzing apparatus including: a receiving unit that receives data of a specific protocol, transmitted from a server to a client; an extraction unit that extracts status codes from the received data; a classification unit that classifies the extracted status codes, into first-type status codes and second-type status codes; and a judgment unit that finds a receiving rate of first-type status codes and a receiving rate of second-type status codes, to compare the receiving rate of first-type status codes against a first threshold value, and the receiving rate of second-type status codes against a second threshold value, and to determine based on results of comparison whether an increase in server load has resulted from a normal traffic or an abnormal traffic.

The present invention also provides a communication system including: a server and a client that are connected to each other via a network and perform communication therebetween in accordance with a specific protocol; and a monitoring/analyzing apparatus that comprises: a receiving unit connected to the network to receive data of a specific protocol, transmitted from the server to the client; an extraction unit that extracts status codes from the received data; a classification unit that classifies the extracted status codes, into first-type status codes and second-type status codes; and a judgment unit that finds a receiving rate of first-type status codes and a receiving rate of second-type status codes, to compare the receiving rate of first-type status codes against a first threshold value, and the receiving rate of second-type status codes against a second threshold value, and to determine based on results of comparison whether an increase in server load has resulted from a normal traffic or an abnormal traffic.

The present invention also provides a monitoring/analyzing method for use in a monitoring/analyzing apparatus designed to receive and analyze data of a specific protocol, transmitted from a server to a client, the method including: extracting, in the monitoring/analyzing apparatus, status codes from the received data; classifying, in the monitoring/analyzing apparatus, the extracted status codes into first-type status codes and second-type status codes; calculating, in the monitoring/analyzing apparatus, a receiving rate of first-type status codes and a receiving rate of second-type status codes; comparing, in the monitoring/analyzing apparatus, the receiving rate of first-type status codes against a first threshold value, and the receiving rate of second-type status codes against a second threshold value; and judging, in the monitoring/analyzing apparatus, based on results of comparison, whether an increase in server load has resulted from a normal traffic or an abnormal traffic.

The present invention also provides a computer readable medium encoded with a computer program on which a central processing unit (CPU) is run for operating a monitoring/analyzing apparatus, the program being capable of causing the CPU to: extract status codes from the received data; classify the extracted status codes into first-type status codes and second-type status codes; calculate a receiving rate of first-type status codes and a receiving rate of second-type status codes; compare the receiving rate of first-type status codes against a first threshold value, and the receiving rate of second-type status codes against a second threshold value; and judge based on results of comparison whether an increase in server load has resulted from a normal traffic or an abnormal traffic.

The above and other objects, features and advantages of the present invention will be more apparent from the following description, referring to the accompanying drawings.

### BRIEF DESCRIPTION OF THE DRAWINGS

FIG. 1 is a block diagram showing an exemplary basic configuration of the monitoring/analyzing apparatus according to the present invention;

FIG. 2 is a block diagram showing a communication system including a monitoring/analyzing apparatus according to a first embodiment of the present invention;

FIG. 3 is a block diagram showing the monitoring/analyzing apparatus shown in FIG. 2;

FIG. 4 is a diagram illustrating an exemplary SIP-session management table;

FIG. 5 is a diagram illustrating an exemplary server list;

FIG. 6 is a diagram illustrating an exemplary status code list;

FIG. 7 is a diagram illustrating an exemplary count table;

FIG. 8 is a diagram showing an exemplary highest receiving rate of 4xx-status codes;

FIG. 9 is a diagram showing an exemplary threshold value table;

FIG. 10 is a flowchart showing the operation procedure of the monitoring/analyzing apparatus shown in FIG. 3;

FIG. 11A is a graph showing a change of the receiving rate of 5xx- and 6xx-status codes with time;

FIG. 11B is a graph showing a change of the receiving rate of 4xx-status codes changes with time;

FIG. 12 is a diagram representing the relation between the receiving rate of 5xx- and 6xx-status codes and the receiving rate of 4xx-status codes;

FIG. 13 is a diagram showing an exemplary status code list used in a second exemplary embodiment of the present invention;

FIG. 14 is a diagram showing an exemplary count table used in the second exemplary embodiment;

FIG. 15 is a diagram showing an exemplary threshold value table used in the second exemplary embodiment;

FIG. 16 is a diagram showing a criterion table; and

FIG. 17 is a flowchart showing the operation procedure of the monitoring/analyzing apparatus of the second exemplary embodiment.

### DETAILED DESCRIPTION OF EMBODIMENTS

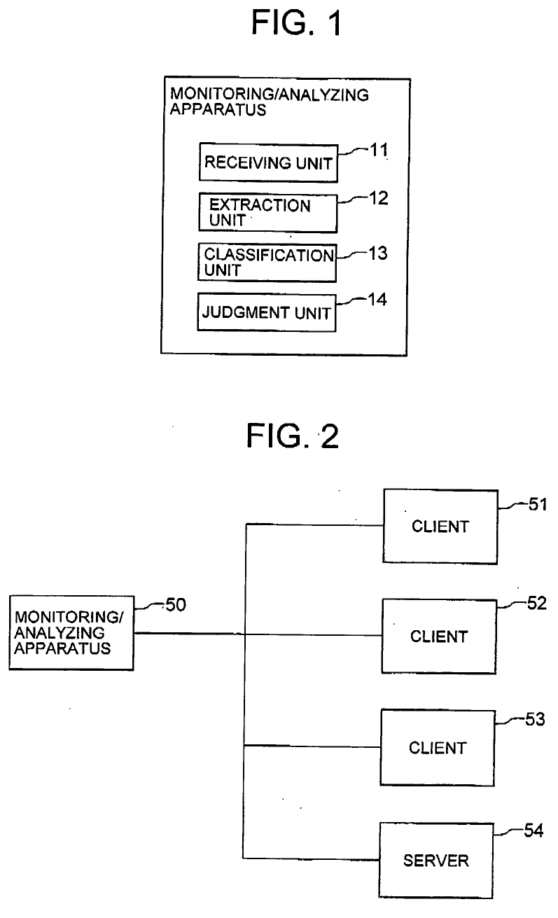

The outline of the present invention will be first described. FIG. 1 shows an exemplified configuration of a monitoring/analyzing apparatus according to the present invention. The monitoring/analyzing apparatus includes a receiving unit 11, an extraction unit 12, a classification unit 13, and a judgment unit 14. The receiving unit 11 receives data transmitted from a server to a client in a prescribed protocol. The extraction unit 12 extracts status codes from data received in the receiving unit 11. The classification unit 13 classifies the status codes extracted by the extraction unit 12, into first type and second type.

The judgment unit 14 determines the receiving rate of first-type status codes and compares the receiving rate of first-type status codes against a threshold value thereof. Similarly, the judgment unit 14 determines the receiving rate of second-type status codes, and compares the receiving rate of second-type status codes against a threshold value thereof. Thereafter, from the result of the comparison, the judgment unit 14 determines whether the increase in the load on the server has been the result of a normal traffic or caused by an abnormal traffic.

In the prevent invention, the status codes are classified into first type and second type. The receiving rate of the first-type status codes and the receiving rate of the second-type status codes are determined and compared against the respective threshold values. Thus, it is determined whether or not the event to which the first-type status codes pertain is normal, and whether or not the event to which the second-type status codes pertain is normal. If one of the events is found abnormal, the other of the events is monitored to infer the factor that has caused the one of the events abnormal.

The classification unit 13 may receive a status code showing that the server cannot execute a request issued by the client because this request is an abnormal one. In this case, the classification unit 13 classifies the status code as a first-type one. Further, the classification unit 13 may receive a status code showing that the server cannot execute the request because of the trouble involved therein, although the request is a normal one. In this case, the classification unit 13 classifies the status code as a second-type one. From the receiving rate of second-type status codes, the load on the server can be grasped. From the receiving rate of first-type status codes, the state in which unauthorized requests have been generated can be grasped. Hence, whether an increase in the server load, if any, has resulted from a normal traffic or caused by an abnormal traffic can be determined by using both the receiving rate of first-type status codes and the receiving rate of second-type status codes.

Now, exemplary embodiments of the present invention will be described in detail with reference to the accompanying drawings. FIG. 2 is a block diagram that shows a communication system including a monitoring/analyzing apparatus according to a first exemplary embodiment. The monitoring/analyzing apparatus 50 is connected to a plurality of clients (51 to 53) and a server 54 via a network. The monitoring/analyzing apparatus 50 receives SIP packets flowing on the same segment. This reception of packets can set in network-interface cards of ordinary type, in the so-called promiscuous mode. The monitoring/analyzing apparatus 50 monitors and analyzes the clients 51 to 53 and the layer 7 (i.e., OSI-model seventh layer, hereinafter referred to as “L7”). The monitoring/analyzing apparatus 50 records the result of monitoring and analysis in a log.

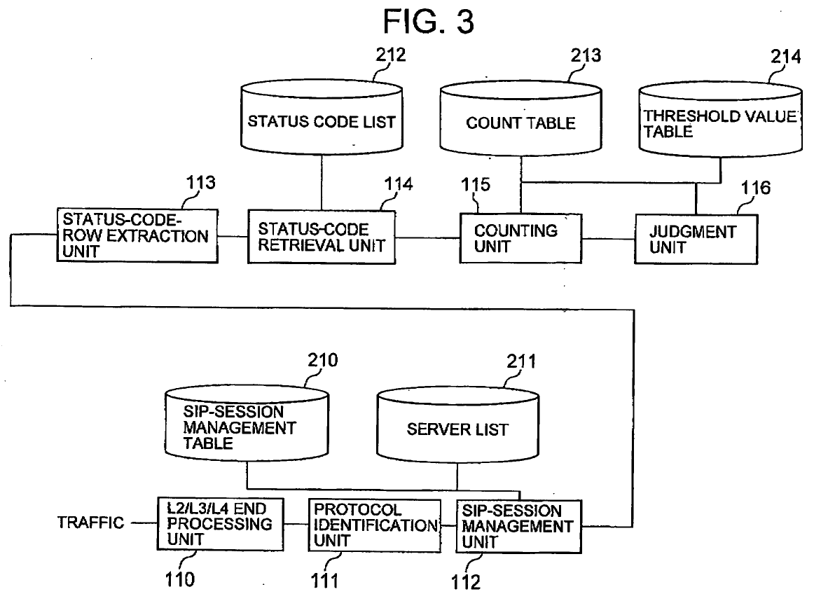

FIG. 3 shows the configuration of the monitoring/analyzing apparatus 50. The monitoring/analyzing apparatus 50 includes an L2/L3/L4 end processing unit 110, a protocol identification unit 111, a SIP-session management unit 112, a status-code-row extraction unit 113, a status-code retrieval unit 114, a counting unit 115, a judgment unit 116, an SIP-session management table 210, a server list 211, a status code list 212, a count table 213, and a threshold value table 214. The monitoring/analyzing apparatus 50 causes a data processing device or CPU to execute a specific program so that each unit may perform its function. The L2/L3/L4 end processing unit 110, protocol identification unit 111 and SIP-session management unit 112 correspond to the receiving unit 11 shown in FIG. 1. The status-code-row extraction unit 113 corresponds to the extraction unit 12, and the status-code retrieval unit 114 corresponds to the classification unit 13. The counting unit 115 and judgment unit 116 correspond to the judgment unit 14.

The L2/L3/L4 end processing unit 110 performs end processing on layer 2 (L2), layer 3 (L3) and layer 4 (L4). The SIP used herein may be TCP, UDP, or SCTP (Stream Control Transmission Potocol, RFC2960). The L2/L3/L4 end processing unit 110 performs stream reconstruction when it receives TCP packets or SCTP packets. The protocol identification unit 111 identifies each SIP packet and transfers the same to the subsequent SIP-session management unit 112. Whether or not the packet received is a SIP packet can be determined from the port number (5060). Any packet other than SIP packets is discarded.

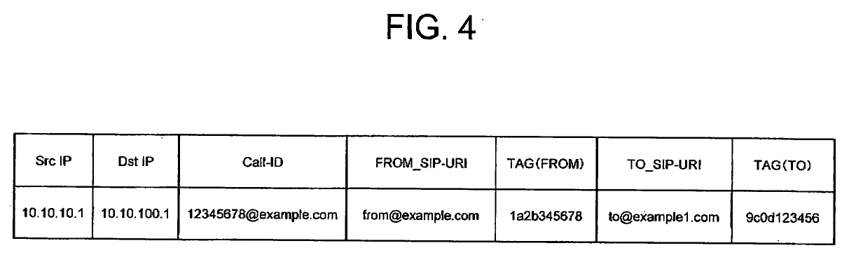

The SIP-session management unit 112 manages any SIP session input to the monitoring/analyzing apparatus 50. From the SIP packet received, the SIP-session management unit 112 extracts information that should be registered in the SIP-session management table 210. The extracted information is registered in the SIP-session management table 210. FIG. 4 shows an example of the SIP-session management table 210. The SIP-session management table 210 includes a plurality of items such as a source IP address, a destination IP address, a call ID, a source SIP-URI, and a destination SIP-URI.

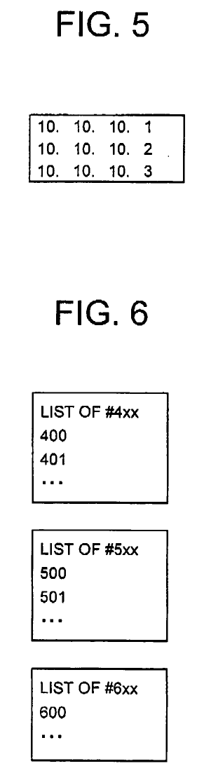

The server list 211 describes the IP address of the target servers that the monitoring/analyzing apparatus 50 monitors and analyzes. FIG. 5 shows exemplary contents of the server list 211. The SIP-session management unit 112 refers to the server list 211 and transfers any SIP packet having a source IP address associated with an IP address described in the server list 211, to the status-code-row extraction unit 113. Upon receiving the SIP packet from the SIP-session management unit 112, the status-code-row extraction unit 113 extracts the status code from the first row of the SIP packet and transfers the extracted status code to the status-code retrieval unit 114.

The status code list 212 describes status codes that should be counted. The status-code retrieval unit 114 compares any status code extracted by the status-code-row extraction unit 113, against the status codes described in the status code list 212, and determines whether or not the status code extracted is identical to any status code described in the status code list 212. If the extracted status code is identical to any status code described in the status code list 212, the status-code retrieval unit 114 generates data showing the status code. This data is supplied to the counting unit 115. More specifically, the status-code retrieval unit 114 retrieves one (4xx) of the 400th to 499th status codes, one (5xx) of the 500th to 599th status codes, and one (6xx) of the 600th to 699th status codes, and informs the counting unit 115 which status codes have been retrieved. The counting unit 115 counts the number of times each status code has been received.

FIG. 6 shows an exemplary status code list that may be stored in the status code list 212. The status code list 212 includes a 4xx-status code list, a 5xx-status code list, and a 6xx-status code list. The status-code retrieval unit 114 may receive status code “401” from the status-code-row extraction unit 113. In this case, the status-code retrieval unit 114 informs the counting unit 115 that the status code received is a 4xx-status code, because the status code received is described in the 4xx-status code list. If the status code received from the status-code-row extraction unit 113 is “501,” the status-code retrieval unit 114 informs the counting unit 115 that the status code received is a 5xx-status code.

The 4xx-status code indicates a client-error response, showing that the request includes an error or that server designated cannot execute the request. In other words, the 4xx-status code is a code showing that the server cannot execute the request because of the error included in the request issued by the client. The 5xx-status code indicates a server-error response, showing that the server has failed to execute the request. The 6xx-status code indicates a global-error response, showing that no server could execute the request. That is, the 5xx-status code and the 6xx-status code are codes that show the server could not execute the request, although the request is a normal one.

As described above, the status code list 212 includes a 4xx-status code list, a 5xx-status code list, and a 6xx-status code list. Nonetheless, the status code list 212 itself may be dispensed with, if these status code lists are used only to determine which hundreds place each status code has. This is because the hundreds place of any status code can be determined without referring to status-code lists. The reason for providing the status code list 212 is that status codes may not be issued as intended because the criteria of defining status code errors differ from an apparatus designer to another apparatus designer. It is assumed here that a server responds, issuing status code “480” when the number of INVITE requests exceeds a threshold value, and that the monitoring/analyzing apparatus intends to detect this event as a server-error response (i.e., 5xx). In this case, the code “480” issued is described in the 5xx-status code list stored in the status code list 212, and the status code “480” can therefore be detected as a 5xx-status code.

When informed that the status-code retrieval unit 114 has detected the status code, the counting unit 115 counts the status code for the IP address of the server that has transmitted the status code. At this stage, the counting unit 115 counts the status code, also for the IP address of the client that receives the status code. The count table 213 holds the number of status codes counted for each server and the number of status codes counted for each client.

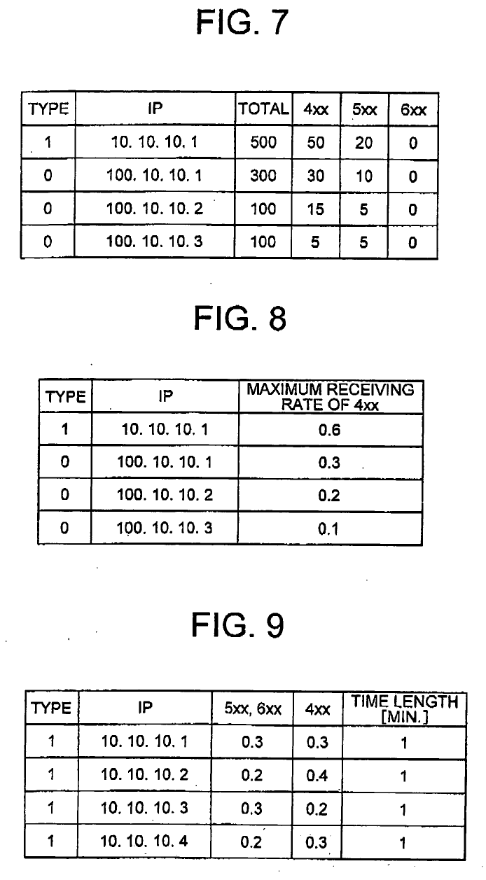

FIG. 7 shows an exemplary count table 213. The count table 213 includes columns (items), i.e., type column, IP address column, total number column, 4xx number column, 5xx number column, and 6xx number column. Two types are available for the information in the columns. One type, or “1” indicates a server, and the other type, or “0” indicates a client. The data items in, for example, the first row of count table 213 (FIG. 7) show that the total number of status codes that the server identified with IP address “10.10.10.1” receives is “500,” the number of 4xx-status codes is “50,” the number of 5xx-status codes is “20”, and the number of 6xx-status codes is “0”. The data items in any row following the first row show the count values for one client communicating with the server having IP address “10.10.10.1”. The count values shown in the count table 213 are updated at regular intervals.

The judgment unit 116 refers to the count table 213, first finding the sum of the number of 5xx-status codes and number of 6xx-status codes, and then dividing the sum by the total number of status codes received. The resultant quotient shall be called “5xx/6xx-receiving rate.” The judgment unit 116 further divides the number of 4xx-status codes counted, by the total number of status codes received. The quotient thus obtained shall be called “4xx-receiving rate.” After obtaining the 4xx-receiving rate, the judgment unit 116 finds the highest of the receiving rates obtained during a prescribed monitoring time. The highest receiving rate thus found is held in a storage device (not shown). FIG. 8 shows the highest receiving rate of 4xx-status codes for each IP address.

The judgment unit 116 judges, based on the receiving rate of the status codes of each type and the threshold receiving rate thereof stored in the threshold value table 214, whether or not the server load has increased. If the server load has increased, the judgment unit 116 then judges whether the server load increase has resulted from an abnormal traffic or a normal traffic. The judgment unit 116 may find that the receiving rate of 5xx-status codes and 6xx-status codes exceed the threshold value stored in the threshold value table 214, and that the highest receiving rate of 4xx-status codes, obtained during the prescribed monitoring time, exceeds the threshold value stored in the threshold value table 214. In this case, the judgment unit 116 judges that the increase of server load has resulted from an abnormal traffic. The receiving rate of 5xx-status codes and 6xx-status codes may exceed the threshold value, and the highest receiving rate of 4xx-status codes, obtained during the prescribed monitoring time period, may exceed the threshold value. In this case, the judgment unit 116 judges that the increase of server load has resulted from a normal traffic.

FIG. 9 shows an exemplary threshold value table 214. The threshold value table 214 includes columns (items) i.e., type column, IP address column, 5xx- and 6xx-threshold column, 4xx-threshold column, and monitoring time column. The 5xx- and 6xx-threshold column shows threshold values that are compared against the receiving rate of 5xx-status codes and 6xx-status codes. The 4xx-threshold column shows the threshold values that are to be compared against the receiving rate of 4xx-status codes. Any data described in the monitoring time column indicates the longest time within the highest receiving rate of 4xx-status codes detected in the past. If the monitoring time period is, for example, one minute, the judgment unit 116 holds the highest receiving rate (FIG. 8) detected in the latest one minute.

To transmit an abnormal traffic, a person with malicious intent may scan the server in preparation for acquisition of the protocol such as SIP-URI. When scanned, the server transmits a 4xx code, which is a client-error response, to the client. When this person transmits an abnormal traffic to the server by using the protocol he or she has acquired, the server transmits a 5xx code, which is a server-error response, to the client. At this stage, the network is monitored. Thereafter, the server appears to transmit larger number of 5xx codes after transmitting a large number of 4xx codes. The judgment unit 116 detects this behavior of the server, determining why the server load has increased. At this stage, the client that has caused the traffic to increase the server load is considered now receiving 4xx codes, 5xx codes and 6xx codes from the server. Therefore, any client that is receiving these codes at a higher receiving rate can be identified as the client that has increased the load imposed on the server.

As described above, the status-code retrieval unit 114 detects whether the status code is 4xx, 5xx or 6xx and the counting unit 115 counts the codes received. The 4xx-status codes, the 5xx-status codes and the 6xx-status codes need not be counted, group by group, since the judgment unit 116 calculates the receiving rate based on the sum of the number of 5xx-status codes and the number of 6xx-status codes. Hence, the status codes that the status-code retrieval unit 114 has detected may be classified into only two types, i.e., 4xx-status codes (first type) and 5xx- and 6xx-status codes (second type). Thus, it is sufficient for the status code list 212 (FIG. 6) to include one list for 5xx-status codes and 6xx-status codes.

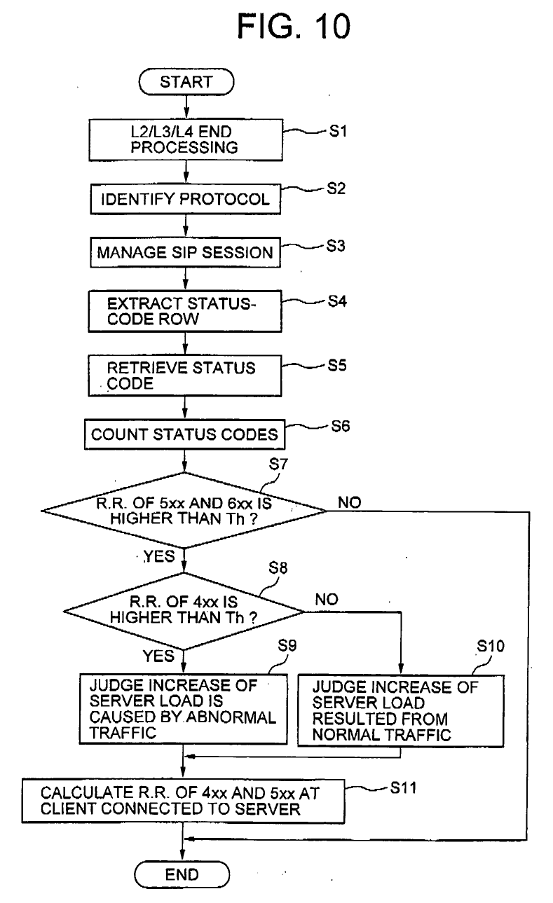

FIG. 10 shows the operation procedure of the monitoring/analyzing apparatus 50. The monitoring/analyzing apparatus 50 receives packets transmitted on the network. The L2/L3/L4 end processing unit 110 performs end processing on the packets it has received (Step S1). In the end processing, any TCP packet and any SCTP packet undergo stream reconstruction. The protocol recognition unit 111 refers to the port number of the packets. The protocol recognition unit 111 transfers a packet having port number 5060, to the SIP-session management unit 112 (Step S2). The protocol recognition unit 111 discards packets other than the packet having port number 5060. Since the packet having port number 5060 indicates a SIP packet, the protocol recognition unit 111 transfers only the SIP packet, as a target packet for processing, to the SIP-session management unit 112.

Upon receiving the SIP packet, the SIP-session management unit 112 refers to the source IP and destination IP (both contained in the IP header of the SIP packet), SIP-URI, and performs SIP-session management by using the SIP-session management table 210 (FIG. 4) (Step S3). At this stage, the SIP-session management unit 112 refers to the server list 211 (FIG. 5), too. The SIP-session management unit 112 then transfers, to the status-code-row extraction unit 113, the SIP packet whose source IP address is identical to the IP address described in the server list 211. Upon receiving the SIP packet whose source IP address is identical to the IP address described in the server list 211, the status-code-row extraction unit 113 extracts the status code of the SIP packet and transfers this status code to the status-code retrieval unit 114 (Step S4).

The status-code retrieval unit 114 refers to the status code list 212 (FIG. 6). If any list contains a status code identical to the status code transferred from the status-code-row extraction unit 113, the status-code retrieval unit 114 informs the counting unit 115 of the list that contains the identical status code (Step S5). In accordance with the information issued by the status-code retrieval unit 114, the counting unit 115 counts the number of status codes received at each server, to thereby update the count table 213 shown in FIG. 7 (Step S6). In Step S6, the counting unit 115 counts the status codes for the client that receives the SIP packet from the server.

The judgment unit 116 refers to the count table 213 at regular intervals, thereby finding the receiving rate of 5xx- and 6xx-status codes from the count of 5xx- and 6xx-status codes. Further, the judgment unit 116 finds the receiving rate of 4xx-status codes from the count of the 4xx-status codes, to thereby update the highest receiving rate of 4xx-status codes (FIG. 8) during the monitoring time period stored in the threshold value table 214 (FIG. 9). The judgment unit 116 compares the receiving rate of 5xx- and 6xx-status codes, found for each server, against the receiving rate of 5xx- and 6xx-status codes, stored in the threshold value table 214. Thus, the judgment unit 116 judges whether the receiving rate (R.R.) found is equal to or higher than the threshold value for 5xx- and 6xx-status codes, which is stored in the threshold value table 214 (Step S7). That is, the judgment unit 116 judges whether or not the server load is large. If the load is smaller than the threshold value, the process comes to an end.

If the receiving rate is equal to or higher than the threshold value for 5xx- and 6xx-status codes (if YES in Step S7), the judgment unit 116 compares the highest receiving rate of 4xx-status codes, measured during the monitoring time period, against the threshold receiving rate of 4xx-status codes, stored in the threshold value table 214. Thus, the judgment unit 116 judges whether the highest receiving rate during the monitoring time period is equal to or higher than the threshold value (Step S8). If the highest receiving rate is equal to or higher than the threshold value, the judgment unit 116 judges that the increase of server load has resulted from an abnormal traffic (Step S9). If the highest receiving rate is lower than the threshold value, the judgment unit 116 judges that the increase of server load has resulted from a normal traffic (Step S10).

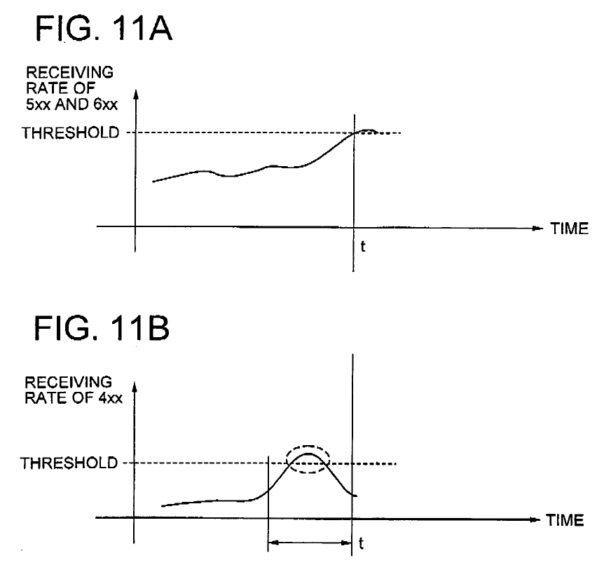

FIG. 11A shows how the receiving rate of 5xx- and 6xx-status codes changes with time, and FIG. 11B shows how the receiving rate of 4xx-status code changes with time. FIGS. 11A and 11B pertain to the case where the server having IP address “10.10.10.1” is used. As understood from FIG. 9, for this server, the threshold receiving rate of 5xx- and 6xx-status codes is “0.3,” the threshold receiving rate of 4xx-status codes is “0.3,” and the monitoring length time is “1 minute.” In Step S7, the judgment unit 116 compares the receiving rate of 5xx- and 6xx-status codes against the threshold value “0.3.” It is assumed here that the receiving rate of 5xx- and 6xx-status codes exceeds the threshold value “0.3” at time instant t (see FIG. 11A).

Thereafter, the judgment unit 116 compares, in Step S8, the highest receiving rate of 4xx-status codes, measured during the monitoring time period, against the threshold receiving rate of 4xx-status codes, i.e., “0.3.” Since the monitoring length time is 1 minute, the highest receiving rate of 4xx-status codes, measured over the period from 1 minute before time instant t to time instant t, is compared against the threshold value “0.3.” As shown in FIG. 11B, the receiving rate of 4xx-status codes is lower than the threshold value “0.3” at time instant t, and is equal to or higher than the threshold value at some time between one minute before time instant t and time instant t. Hence, in Step S8, the highest receiving rate of 4xx-status codes is regarded as equal to or higher than the threshold value. As a result, in Step S8, the server load is determined to have increased due to an abnormal traffic.

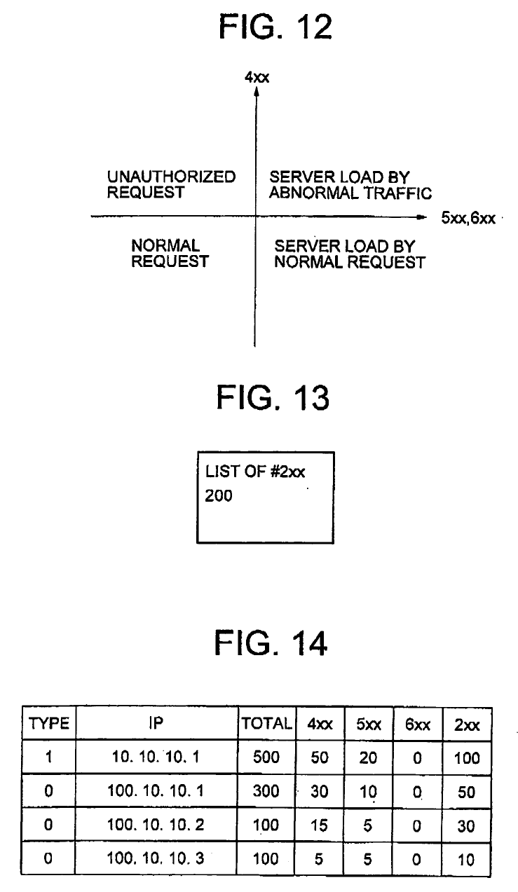

FIG. 12 illustrates the relation between the receiving rate of 4xx-status codes and the receiving rate of 5xx- and 6xx-status codes. In FIG. 12, two states in which the receiving rate of 5xx- and 6xx-status codes is higher than the threshold value are plotted in the first and fourth quadrants, respectively. Two states in which the receiving rate of 5xx- and 6xx-status codes is equal to or lower than the threshold value are plotted in the second and third quadrants, respectively. Further, two states in which the receiving rate of 4xx-status codes during the monitoring time period is equal to or higher than the threshold value thereof are plotted in the first and second quadrants, respectively, and two states in which the receiving rate of 4xx-codes is lower than the threshold value are plotted in the third and fourth quadrants, respectively.

The receiving rate of 5xx- and 6xx-status codes may be equal to or higher than the threshold value, if 5xx-status codes are issued because the server fails, due to a large number of traffic such as SPIT, to secure a storage area for the threads to be processed. On the other hand, the highest receiving rate of 4xx-status codes during the monitoring time period may be equal to or higher than the threshold value, when a person with malicious intent transmits an OPTIONS request for SIP in an attempt to acquire SIP-URI and the server has no SIP-URI, and thus 4xx-status codes (e.g., 404 Not Found) are repetitively issued.

In the state plotted in the first quadrant, an unauthorized request was issued in the past and a large number of traffics occurred. Therefore, it can be determined that an abnormal traffic has increased the server load in this state. In the state plotted in the fourth quadrant, unauthorized requests were not issued in the past, although a large number of traffic occurred. Therefore, it can be said that a normal traffic has increased the server load in this state. In the state plotted in the second quadrant, an unauthorized request was indeed issued in the past but no large number of traffic occurred. Therefore, a large number of traffic may occur due to the use of the information acquired by issuing an unauthorized request. In the state plotted in the third quadrant, a normal traffic is believed to occur hereafter because neither the receiving rate of 4xx-status codes nor the receiving rate of 5xx- and 6xx-status codes is equal to or higher than the threshold value.

Back to FIG. 10, the judgment unit 116 refers to the count table 213 (FIG. 7), to thereby obtain the receiving rate of 4xx-status codes and the receiving rate of 5xx- and 6xx-status codes, both at the client that is connected to the server (Step S11). The receiving rates at the client connected to the server can be obtained from the values described in those rows of the count table 213, which pertains to type “0.” Any client receiving status codes at a high rate can be considered generating a large number of traffics that may increase the load on the server.

In this embodiment, status codes are extracted from the SIP packets transmitted from the server and classified to 4xx-status codes (first type) and 5xx- and 6xx-status codes (second type), and the receiving rate of 4xx-status codes and the receiving rate of 5xx- and 6xx-status codes are obtained. Thereafter, the receiving rate of 4xx-status codes are compared against the receiving rate of 5xx- and 6xx-status codes, determining whether the server load is high or not. If the server load is high, the highest receiving rate of 4xx-status codes is compared against the threshold of the 4xx-status code receiving rate at monitoring time, whereby it is judged whether or not a large number of unauthorized requests have been issued before the server load had increased. Whether the increase in the server load has resulted from an abnormal traffic or a normal traffic can therefore be inferred. That is, which factor, an abnormal traffic or a normal traffic, has increased the server traffic can be determined.

Which factor has increased the server traffic can be determined by two techniques. One technique is to use a pattern characterized by an unauthorized traffic. The other technique is to use a combination of the use rates of the CPU, disk and memory all incorporated in the server. In either technique, both the state of the network and the internal state of the server must be monitored. Further, each information item cannot be easily checked against any other information item. Moreover, many patterns having characteristics of various unauthorized traffics must be prepared in advance. The present embodiment is free of these requirements, because which factor has increased the server traffic is determined from the receiving rate of status codes of one type and the receiving rate of status codes of the other type. That is, this determination can be easily made in the present exemplary embodiment.

A second exemplary embodiment of the present invention will be described hereinafter. A monitoring/analyzing apparatus according to the present exemplary embodiment has a configuration similar to that of the monitoring/analyzing apparatus 50 of the first exemplary embodiment, which is shown in FIG. 3. In the present exemplary embodiment, the receiving rate of 2xx-status codes is used, in addition to the receiving rate of 4xx-status codes and the receiving rate of 5xx- and 6xx-status codes. That is, status codes of another type are used in addition to the two types used in the first exemplary embodiment, to thereby judge whether the increase in the server load is caused by an abnormal traffic or a normal traffic. More precisely, whether the increase in the server load is caused by an abnormal traffic or a normal traffic is judged based on the receiving rate of 4xx-status codes (first type), the receiving rate of 5xx- and 6xx-status codes (second type), and the receiving rate of 2xx-status codes (third type). It is to be noted that the 2xx-status codes represent a successful response each.

FIG. 13 shows a list of 2xx-status codes. The status codes list 212 stores a 2xx-status codes list shown in FIG. 13, in addition to the 4xx-status codes list and the 5xx- and 6xx-status codes list, both shown in FIG. 6. The status codes that the status-code-row extraction unit 113 has extracted may exist in the 2xx-status codes list. In this case, the status-code retrieval unit 114 informs the counting unit 115 of the detection of the 2xx-status codes. FIG. 14 shows an exemplary count table 213 for use in the second exemplary embodiment. This table differs from the count table 213 shown in FIG. 7 and used in the first exemplary embodiment, in that a column is added for the 2xx-status codes in the present embodiment. The counting unit 115 increases the count of 2xx-status codes by one each time the status-code retrieval unit 114 detects a 2xx-status code. The judgment unit 116 refers to the count table 213, determining the receiving rate of 2xx-status codes from the count of 2xx-status codes.

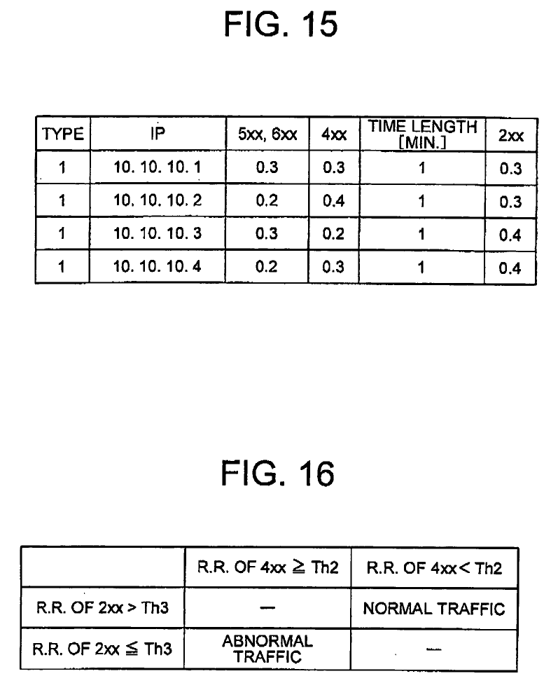

FIG. 15 shows an exemplary threshold value table 214 for use in this exemplary embodiment. This table 214 differs from the threshold value table 214 used in the first exemplary embodiment, in that the table 24 describes the threshold value for the receiving rate of 2xx-status codes in addition to the threshold values for the receiving rate of 4xx-status codes and receiving rate of 5xx- and 6xx-status codes. If the receiving rate of 5xx- and 6xx-status codes is equal to or higher than the threshold value, the judgment unit 116 compares the receiving rate of 4xx-status codes against the threshold value thereof, the receiving rate of 2xx-status codes against the threshold value thereof. Thus, the judgment unit 116 judges whether the increase in the server load has resulted from an abnormal traffic or a normal traffic, in accordance with the table shown in FIG. 16. As understood from FIG. 16, the judgment unit 116 judges that the increase in the server load has resulted from an abnormal traffic if the receiving rate (R.R.) of 4xx-status codes is equal to or higher than the threshold value (Th) and if the receiving rate of 2xx-status codes is equal to or lower than the threshold value. On the other hand, if the receiving rate of 4xx-status codes is lower than the threshold value and if the receiving rate of 2xx-status codes is higher than the threshold value, the judgment unit 116 judges that the increase in the server load has resulted from a normal traffic.

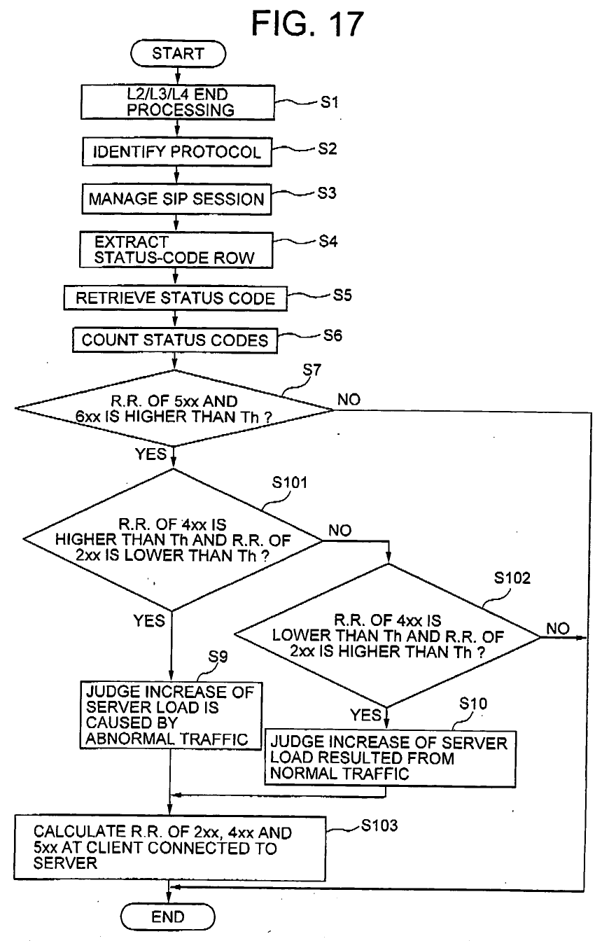

FIG. 17 is a diagram that depicts the operation procedure of the monitoring/analyzing apparatus according to the second exemplary embodiment. Steps S1 to Step 6 are similar to those performed in the first exemplary embodiment. The judgment unit 116 refers to the threshold value table 214 and compares the receiving rate of 5xx- and 6xx-status codes against the threshold value thereof, determining whether the receiving rate of 5xx- and 6xx-status codes is equal to or higher than the threshold value (Step S7). If the receiving rate is lower than the threshold value, the process comes to an end.

In Step S7, the judgment unit 116 may determine that the receiving rate of 5xx- and 6xx-status codes is equal to or higher than the threshold value. If this is the case, the judgment unit 116 refers to the threshold value table 214, comparing the receiving rate of 4xx-status codes against the threshold value thereof, and the receiving rate of 2xx-status codes against the threshold value thereof. The judgment unit 116 judges whether the receiving rate of 4xx-status codes is equal to or higher than the threshold value thereof and whether the receiving rate of 2xx-status codes is equal to or lower than the threshold value thereof (Step S101). If the receiving rate of 4xx-status codes is equal to or higher than the threshold value and the receiving rate of 2xx-status codes is equal to or lower than the threshold value, the judgment unit 116 judges that the increase in the server load has resulted from an abnormal traffic (Step S9). Thereafter, the judgment unit 116 refers to the count table 213, finding the receiving rate of 4xx-status codes, the receiving rate of 5xx- and 6xx-status codes and the receiving rate of 2xx-status codes, all pertaining to the client (type “0”) (Step S103). Any client that has high receiving rates is considered to have generated a large number of traffics that may result in an increase of the server load.

In Step S101, the judgment unit 116 may determine that the receiving rate of 4xx-status codes is equal to or higher than the threshold value and that the receiving rate of 2xx-status codes is not lower than the threshold value. In this case, the judgment unit 116 judges whether or not the receiving rate of 4xx-status codes is lower than the threshold value and whether or not the receiving rate of 2xx-status codes exceeds the threshold value (Step S102). If the receiving rate of 4xx-status codes is lower than the threshold value and if the receiving rate of 2xx-status codes exceeds the threshold value, the judgment unit 116 judges that the increase in the server load has resulted from a normal traffic (Step S10). Thereafter, the process advances to Step S103, in which the judgment unit 116 finds the receiving rate of 4xx-status codes, the receiving rate of 5xx- and 6xx-status codes and the receiving rate of 2xx-status codes. If the receiving rate of 4xx-status codes is equal to or higher than the threshold value, or if the receiving rate of 2xx-status codes is equal to or lower than the threshold value in Step S102, the process comes to an end.

In this exemplary embodiment, status codes of another type (third type) are used in addition to the two types used in the first exemplary embodiment. In other words, all status codes used are classified into three types, i.e., 4xx-status codes (first type), 5xx- and 6xx-status codes (second type) and 2xx-status codes (third type). The receiving rate of 2xx-status codes is measured and used to determine the cause of increasing the load on the server. Hence, the cause can be inferred more accurately than in the first exemplary embodiment.

The protocol used in the exemplary embodiments as described above is SIP. The protocol is not limited to SIP, nevertheless. HTTP, for example, can be used in the present invention. 600th to 699th status codes are available in SIP, whereas these status codes are not available in HTTP. In HTTP, 500th to 599th status codes may be used and processed as status codes of the second type. In the case where HTTP is used in the apparatus, the server issues a “400 Bad Request” if the request is erroneous in terms of sentence structure and issues a “503 Service Unavailable” if the server load is increased. Hence, whether or not a large number of 400th to 499th status codes have generated is determined before a large number of “503” status codes are generated. The increase in the server load is caused by either a normal traffic or an abnormal traffic can therefore be determined.

While the invention has been particularly shown and described with reference to exemplary embodiment and modifications thereof, the invention is not limited to these embodiment and modifications. It will be understood by those of ordinary skill in the art that various changes in form and details may be made therein without departing from the spirit and scope of the present invention as defined in the claims.

What is claimed is:

1. A monitoring/analyzing apparatus comprising:
a receiving unit that receives data of a specific protocol, transmitted from a server to a client;
an extraction unit that extracts status codes from the received data;
a classification unit that classifies the extracted status codes, into first-type status codes and second-type status codes; and
a judgment unit that finds a receiving rate of first-type status codes and a receiving rate of second-type status codes, to compare the receiving rate of first-type status codes against a first threshold value, and the receiving rate of second-type status codes against a second threshold value, and to determine based on results of comparison whether an increase in server load has resulted from a normal traffic or an abnormal traffic.

2. The monitoring/analyzing apparatus according to claim 1, wherein said classification unit classifies, as a first-type status codes, any status code indicating that the server cannot execute a request issued by the client because the request is an abnormal one, and classifies, as a second-type status code, any status code indicating that the server cannot execute the request because the server has a trouble, although the request is a normal one.

3. The monitoring/analyzing apparatus according to claim 1, wherein said judgment unit refers to a threshold value table storing therein said first threshold value and second threshold value for each server.

4. The monitoring/analyzing apparatus according to claim 1, wherein said classification unit refers to a status code list storing therein status codes to be classified into first-type status codes and second-type status codes.

5. The monitoring/analyzing apparatus according to claim 1, wherein said judgment unit judges that the server load has increased because of an abnormal traffic if the receiving rate of second-type status codes is equal to or higher than said second threshold value and a highest receiving rate of first-type status codes during a prescribed monitoring time period is equal to or higher than said first threshold values.

6. The monitoring/analyzing apparatus according to claim 1, wherein said judgment unit judges that the server load has increased because of a normal traffic when the receiving rate of second-type status codes is equal to or higher than said second threshold value and a highest receiving rate of first-type status codes during a prescribed monitoring time period is lower than said first threshold value.

7. The monitoring/analyzing apparatus according to claim 1, wherein said classification unit additionally classifies the extracted status codes into third-type status codes, and said judgment unit additionally finds a receiving rate of third-type status codes, additionally compares the receiving rate of third-type status codes against a third threshold value, for judgment.

8. The monitoring/analyzing apparatus according to claim 7, wherein said classification unit classifies, as a third-type status code, any status code indicating that the server has successfully executed a request issued by the client.

9. The monitoring/analyzing apparatus according to claim 7, wherein said judgment unit judges that the server load has increased because of an abnormal traffic if the receiving rate of second-type status codes is equal to or higher than said second threshold value and a highest receiving rate of first-type status codes during a prescribed monitoring time period is equal to or higher than said second threshold value and if the receiving rate of third-type status codes is equal to or lower than said third threshold value.

10. The monitoring/analyzing apparatus according to claim 7, wherein said judgment unit judges that the server load has increased because of a normal traffic if the receiving rate of second-type status codes is equal to or higher than said second threshold value and a highest receiving rate of first-type status codes during a prescribed monitoring time period is lower than said second threshold value and if the receiving rate of third-type status codes is higher than said third threshold value.

11. The monitoring/analyzing apparatus according to claim 7, wherein said specific protocol is session initiation protocol (SIP), and said classification unit classifies 400th to 499th status codes as first-type status codes and 500th to 699th status codes as second-type status codes.

12. The monitoring/analyzing apparatus according to claim 7, wherein said specific protocol is session initiation protocol (SIP), and said classification unit classifies 400th to 499th status codes as first-type status codes, 500th to 699th status codes as second-type status codes and 200th to 299th status codes as third-type status codes.

13. A communication system comprising: a server and a client that are connected to each other via a network and perform communication therebetween in accordance with a specific protocol; and a monitoring/analyzing apparatus that comprises:
a receiving unit connected to the network to receive data of a specific protocol, transmitted from said server to said client;
an extraction unit that extracts status codes from the received data;
a classification unit that classifies the extracted status codes, into first-type status codes and second-type status codes; and
a judgment unit that finds a receiving rate of first-type status codes and a receiving rate of second-type status codes, to compare the receiving rate of first-type status codes against a first threshold value, and the receiving rate of second-type status codes against a second threshold value, and to determine based on results of comparison whether an increase in server load has resulted from a normal traffic or an abnormal traffic.

14. A monitoring/analyzing method for use in a monitoring/analyzing apparatus designed to receive and analyze data of a specific protocol, transmitted from a server to a client, said method comprising:
extracting, in the monitoring/analyzing apparatus, status codes from the received data;
classifying, in the monitoring/analyzing apparatus, the extracted status codes into first-type status codes and second-type status codes;
calculating, in the monitoring/analyzing apparatus, a receiving rate of first-type status codes and a receiving rate of second-type status codes;
comparing, in the monitoring/analyzing apparatus, the receiving rate of first-type status codes against a first threshold value, and the receiving rate of second-type status codes against a second threshold value; and
judging, in the monitoring/analyzing apparatus, based on results of comparison, whether an increase in server load has resulted from a normal traffic or an abnormal traffic.

15. The monitoring/analyzing method according to claim 14, wherein said classifying classifies, as a first-type status codes, any status code indicating that the server cannot execute a request issued by the client because the request is an abnormal one, and classifies, as a second-type status code, any status code indicating that the server cannot execute the request because the server has a trouble, although the request is a normal one.

16. The monitoring/analyzing method according to claim 14, wherein said comparing refers to a threshold value table storing therein said first threshold value and second threshold value.

17. The monitoring/analyzing method according to claim 14, wherein said classifying refers to a status code list storing therein status codes to be classified into first-type ones and second-type ones.

18. The monitoring/analyzing method according to claim 14, wherein said judging judges that the server load has increased because of an abnormal traffic if the receiving rate of second-type status codes is equal to or higher than said second threshold value and a highest receiving rate of first-type status codes during a prescribed monitoring time period is equal to or higher than said first threshold value.

19. The monitoring/analyzing method according to claim 14, wherein said classifying additionally classifies the extracted status codes into third-type status codes, said calculating additionally calculates a receiving rate of third-type status codes, and said comparing additionally compares the receiving rate of third-type status codes against a third threshold value for judgment.

20. The monitoring/analyzing method according to claim 19, wherein said classifying classifies, as a third-type status code, any status code indicating that the server has successfully executed a request issued by the client.

21. The monitoring/analyzing method according to claim 19, wherein said judging judges that the server load has increased because of an abnormal traffic if the receiving rate of second-type status codes is equal to or higher than the said second threshold value and a highest receiving rate of first-type status codes during a prescribed monitoring time period is equal to or higher than said first threshold value and if the receiving rate of third-type status codes is equal to or lower than said third threshold value.

22. A computer readable medium encoded with a computer program on which a central processing unit (CPU) is run for operating a monitoring/analyzing apparatus, said program being capable of causing said CPU to:
extract status codes from the received data;
classify the extracted status codes into first-type status codes and second-type status codes;
calculate a receiving rate of first-type status codes and a receiving rate of second-type status codes;
compare the receiving rate of first-type status codes against a first threshold value, and the receiving rate of second-type status codes against a second threshold value; and
judge based on results of comparison whether an increase in server load has resulted from a normal traffic or an abnormal traffic.
